(19) United States
(12) Patent Application Publication
(10) Pub. No.: US 2018/0118078 A1
(43) Pub. Date: May 3, 2018

(54) Autonomous mobile automated storage and retrieval system and operating model for on-demand electronic commerce

(71) Applicants: Abdullah Hassan Alkhaldi, Mississauga (CA); Omar Amin Al Sati, Mississauga (CA)

(72) Inventors: Abdullah Hassan Alkhaldi, Mississauga (CA); Omar Amin Al Sati, Mississauga (CA)

(21) Appl. No.: 15/406,865

(22) Filed: Jan. 16, 2017

Related U.S. Application Data
(60) Provisional application No. 62/279,212, filed on Jan. 15, 2016.

(51) Int. Cl. B60P 3/025; G06Q 10/08; G06Q 30/06

(52) U.S. Cl. CPC B60P 3/0257; G06Q 10/087; G06Q 30/0635; G06Q 30/0603; G06Q 10/083

(57) ABSTRACT

A self-driving mobile store that contains an automated storage and retrieval system and operating model capable of dispensing products on the move for on-demand electronic commerce to enable increased operational capacity and speed of delivery to customer orders with minimum manpower requirement

### FIELD

The present invention is directed to significantly improving efficiency and speed of on-demand e-commerce by using mobile automated storage and retrieval systems in addition to efficient operating model to fulfill customer orders.

The invention is in Supply chain and logistics operation design where it aims at combining the automated order fulfillment with last mile delivery in one operation resulting in faster and lower cost operation for e-commerce order fulfillment and delivery.

### BACKGROUND

Current e-commerce operational model has a costly operation in order fulfillment and last mile delivery that results in negative operating margins for most e-commerce companies.

In logistics, Automated storage and retrieval systems (AS/RS) are currently only used in fixed environments like warehouses and mega distribution centers, some are customized for use in stationary vending machines.

Major e-commerce companies are adopting a model where they are renting floors in high density downtowns and converting them into warehousing facilities to minimize distance traveled to deliver orders and thereby reduce cost.

### BRIEF DESCRIPTION OF THE DRAWINGS

Reference will now be made, by way of example, to the accompanying drawings which show example embodiments of the present application, and in which:

FIG. 1 is a logical flowchart of customer order from order placement to order delivery and inventory replenishment

FIG. 2, FIG. 3: Design of autonomous (i.e. self-driving) automated storage and retrieval (AS/RS) installed in box truck

FIG. 4, FIG. 5, FIG. 6: Design of products rack with adjustable shelving units.

FIG. 7, FIG. 8, FIG. 9: Design of AS/RS structure including robotic arm, with a mechanism to pull products and a sensor to check if product is collected. Arm has a basket to collect received products and dispense them in truck driver cabin. This robotic arm can function both in stationary and moving truck positions.

### DESCRIPTION OF EXAMPLE EMBODIMENTS

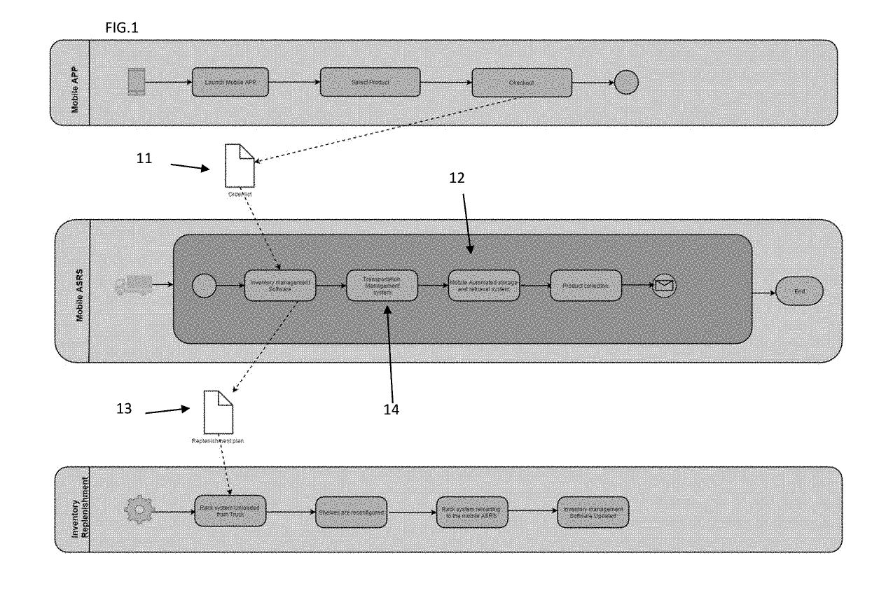

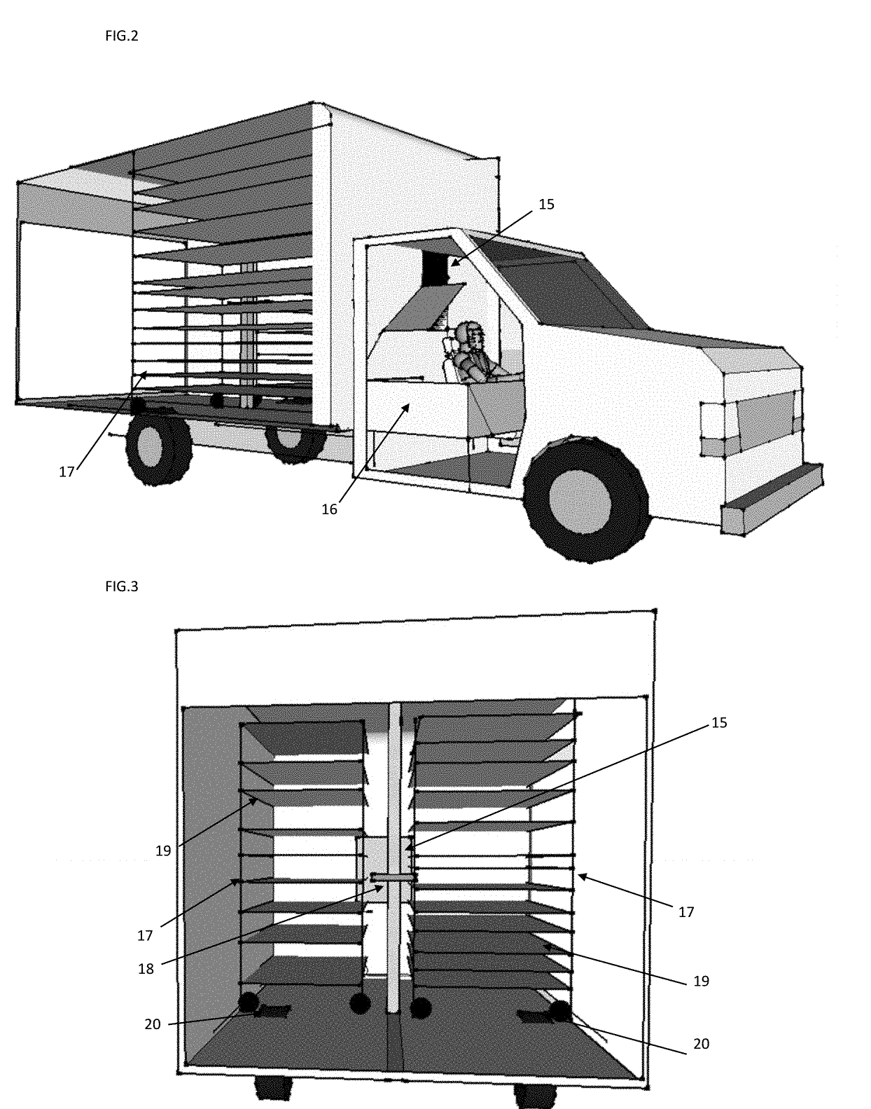

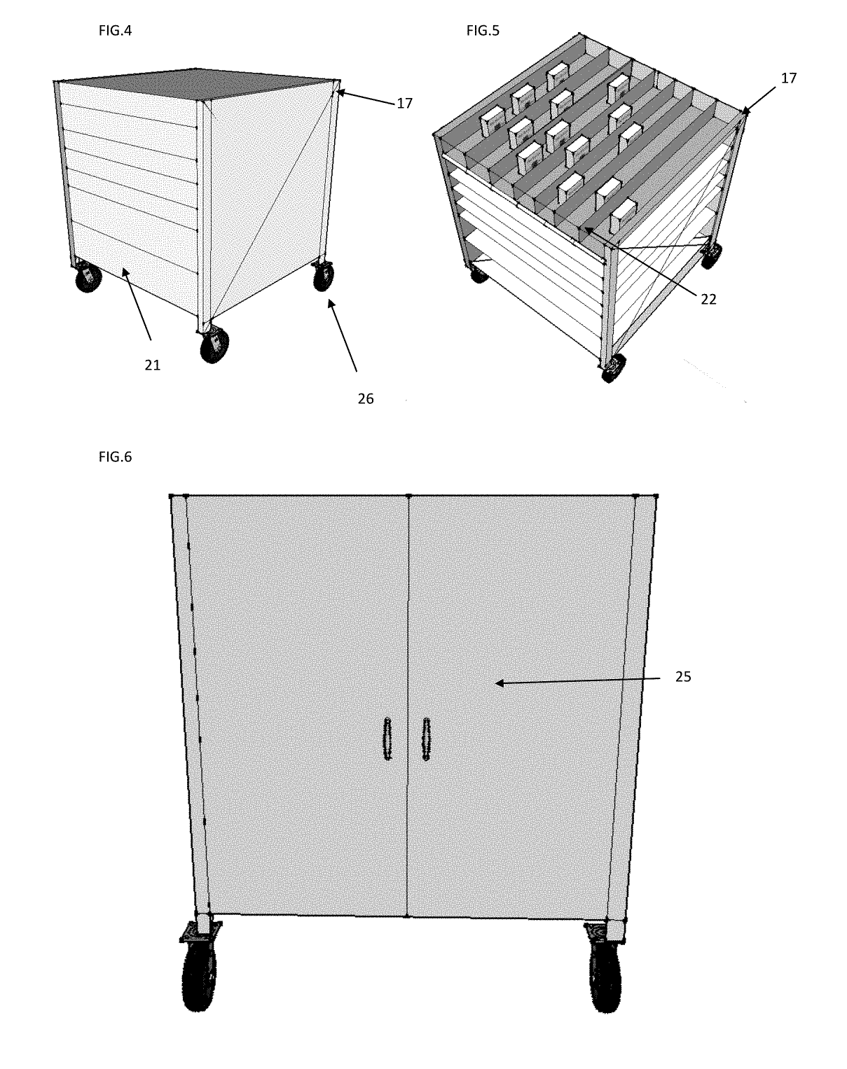

The invention relies on three main components as highlighted in FIG. 1, a mobile application operated by customer, a mobile (AS/RS) with climate controlled capability (−18 C to 50 C) that is self-driven or operated by truck operators, and an automated stock replenishment system in the operation centers.

Mobile application takes into consideration the customer location to show specific product catalogs available in the trucks within a predefined proximity from customer (i.e. a customer will be able to only see items available in trucks (one or more) that are within e.g. 4 miles). Customer will then place an order through a standard e-commerce process. The placed customer order is then sent to both the truck (AS/RS) to dispense requested items and to inventory replenishment system to allocate stock refill. Dispensed items from (AS/RS) are pushed through a window opening between box and cabin 15 to truck cabin collection box 16. This is taking place while the truck is moving towards its delivery destination. Truck operator is notified through the transportation management system 14 (TMS) screen and guided through global positioning system (GPS) technology to his next delivery destination. When operator is at the destination he will deliver the order and will confirm delivery through the (TMS) and a delivery notification will be sent to the customer accordingly.

When truck is back to the operation center, product racks 17 are unloaded from truck while robotic arm 18 is fixed in the box truck. Product racks 17 are automatically unloaded on a guiding track that takes them to stock reloading station for refill. Product racks 17 are then ready to be loaded again on the box truck for the next operating shift.

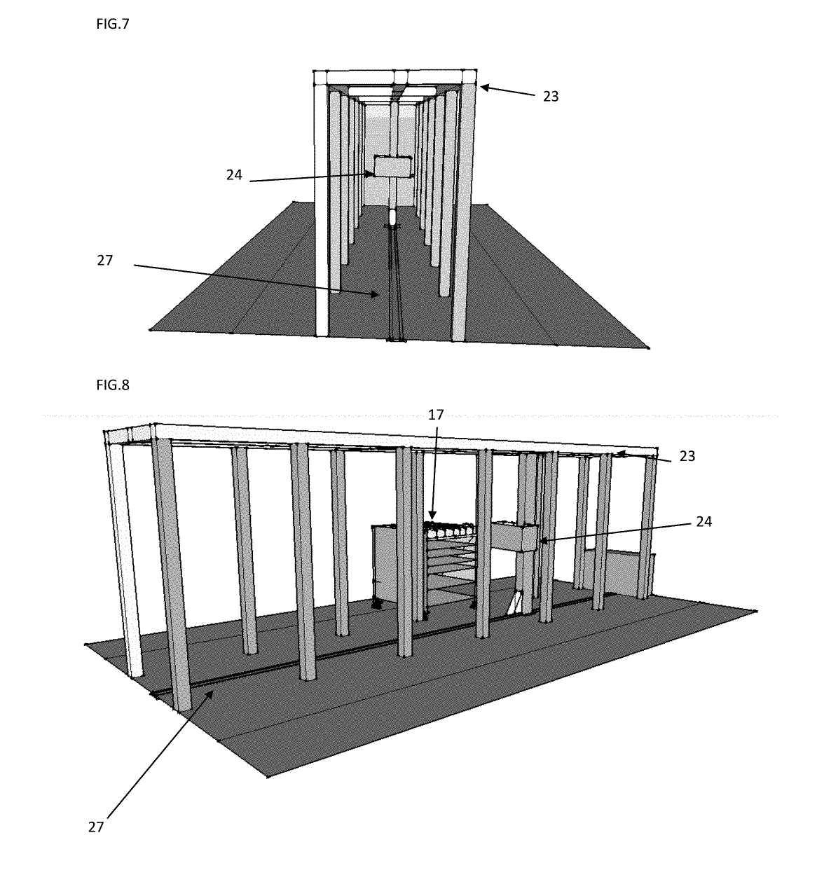

FIG. 3 shows a view from the back of the truck containing two product racks 17, to the right and left of robotic arm 18. Rack shelves 19 have adjustable height and widths to accommodate different product dimensions. They have a locking mechanism 20 to fix them on the box while truck is in moving position. As shown in FIG. 4, There is also an automated cover 21 on the product rack to prevent products from falling from the shelves. FIG. 5 shows separators 22 to segregate different products and allow robotic arm to retrieve items separately through a conveyer mechanism.

Robotic arm 18 is designed to pull products from product racks 17 placed on the right or left of the AS/RS structure 23. It comes in two forms: 1) a flat surface designed to handle dispensing regular shaped products 18, and 2) a basket shaped container, designed to handle multiple products collection or irregular shaped products 24.

FIG. 5 shows one product rack with the design of product shelves separators. Products are pulled through conveyer mechanism to robotic arm 18. FIG. 6 shows the back of the product rack with a back door 25

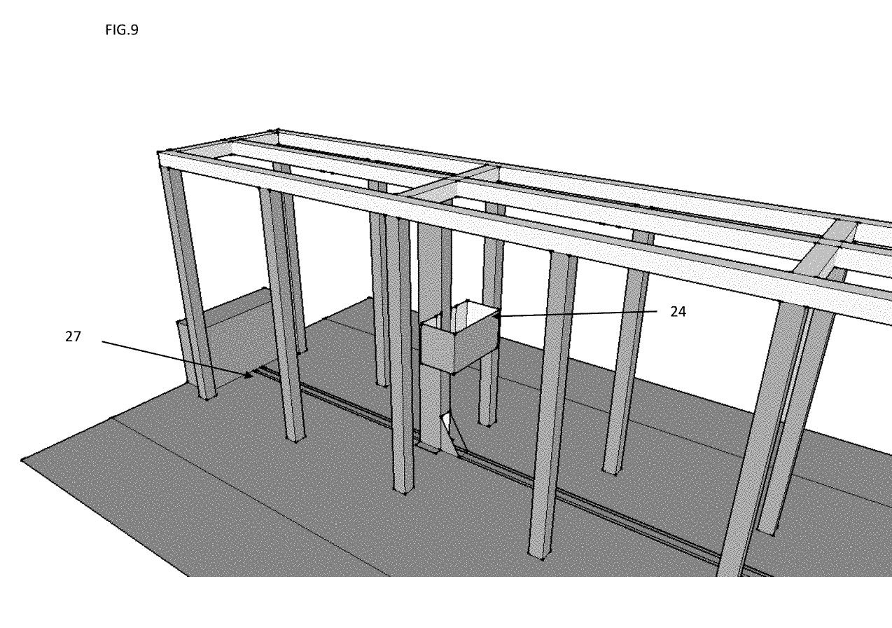

FIG. 7 and FIG. 9 show the structure of the AS/RS 23 fixed on the back of the truck to handle pulling products from both sides and the robotic arm basket design 24, while FIG. 8 shows how product rack 17 is positioned in relation to structure and robotic arm

Certain adaptations and modifications of the described embodiments can be made. Therefore, the above discussed embodiments are considered to be illustrative and not restrictive.

### LIST OF COMPONENTS

11 Order List
12 Mobile ASRS in a truck
13 Replenishment List
14 Transportation Management System
15 Dispensing Window
16 Collection Box
17 Product Racks
18 Robotic Arm
19 Rack Shelves
20 Locking Mechanism
21 Automated Rack Cover
22 Product Separator
23 Frame Structure
24 Basket shaped Container
25 Rack back door
26 Rack Wheel
27 Guiding Track

What is claimed is:

1. Autonomous automated store that handles order fulfillment and last mile delivery simultaneously using mobile technology and dynamic product catalog that shows products availability based on trucks proximity from customers
A mobile automated storage and retrieval system that is capable of dispensing items on the move in response to customer request and location
A supply chain design where order fulfillment and last mile delivery are combined with capacity to store and process thousands of items
A mobile satellite warehouse that can perform package sorting process on the move to improve the process of package delivery services
A mobile storage and retrieval system that dispenses products in the driver cabin to save item picking time and optimize the delivery process
